(19) United States
(12) Patent Application Publication
(10) Pub. No.: US 2006/0212566 A1
(43) Pub. Date: Sep. 21, 2006

(54) Remote control method and device controlled from communicating terminals

(75) Inventors: Claude Boujard, Bordeaux (FR); Franck Fournier, Bordeaux (FR); Jose Vilaldach, Le Bouscat (FR)

Correspondence Address: EGBERT LAW OFFICES, 412 MAIN STREET, 7TH FLOOR, HOUSTON, TX, 77002, US

(73) Assignee: C-ZAME TECHNOLOGES, Pessac (FR)

(21) Appl. No.: 10/560,518

(22) PCT Filed: Jun. 11, 2004
(86) PCT No.: PCT/EP04/51092

§ 371 Date: Mar. 9, 2006

(30) Foreign Application Priority Data
Jun. 13, 2003 (FR) 0307147

(51) Int. Cl. G06F 15/173

(52) U.S. Cl. 709/224

(57) ABSTRACT

The inventive remote control method includes opening a first communication session between a calling terminal and a centralized information system by a telecommunication network, transmitting the identifier of the calling terminal user to the centralized information system, the identifier of the information system being transmitted to a remote control by the telecommunication network, and verifying the identifier with the aid of the centralized information system. In the case of the positive verification result, the method includes transmitting an authorization from the centralized information system to a remote control information system and performing the authorized command thereby.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention concerns a method and a management device for remote controls ordered from communicating terminals. It applies in particular to the remote control of portals, gates or terminals.

### BACKGROUND OF THE INVENTION

Parking spaces reserved for the handicapped are frequently occupied by unauthorized persons.

This invention aims to remedy these inconveniences.

### BRIEF SUMMARY OF THE INVENTION

For that purpose, this invention proposes, according to a first aspect, a remote control method which is characterized by the fact that it comprises:
a step of opening an initial communication session through the intermediary of a telecommunication network, between a calling terminal and a centralized computer system,
a step of transmitting an identifier from the user of the calling terminal to the centralized computer system and of an identifier of a computer system to be remote-controlled, through the intermediary of the telecommunication network,
a step of verification of said identifier by the centralized computer system, and
if the verification is positive:
   a step of transmitting an authorization, from the centralized computer system to the computer system to be remote-controlled; and
   a step of executing the order that has been authorized by the computer system to be remote-controlled.

Thanks to these provisions, the user can select the computer system to be remote-controlled, for instance a mobile terminal or a parking barrier, without knowing the address of the computer system to be remote-controlled on the telecommunication network. For instance, a handicapped person selects the address which he wants to reach by car and the computer system reserves for him the handicapped parking space that is nearest to that address.

The manager of the parking spaces has now the assurance that the spaces reserved for the handicapped cannot be used by unauthorized persons.

According to particular characteristics, the method such as succinctly described above comprises, as a preliminary to the step of transmission of an identifier from a computer system to be remote-controlled, through the intermediary of the telecommunication network, a step of communication between the computer system to be remote-controlled and the calling terminal, during which the computer system to be remote-controlled transmits its identifier to the calling terminal.

Thanks to these provisions, when the user arrives in the proximity of the computer system to be remote-controlled, he receives his identifier and then transmits it to the centralized computer system in order to order the computer system to be remote-controlled.

According to particular characteristics the method such as succinctly described above comprises, in case of unauthorized use of the computer system to be remote-controlled, a step of communication during which the computer system to be remote-controlled sends some representative information of unauthorized utilization.

Thanks to these provisions, the unauthorized user can be contacted to ask him to cease the unauthorized use of the computer system to be remote-controlled or surveillance services and if applicable, the police can be informed of the unauthorized use.

According to particular characteristics the method such as succinctly described above comprises a step of verification of the availability of the computer system to be remote-controlled by the centralized computer system.

Thanks to these provisions, the user can be informed of the availability of the computer system to be remote-controlled.

According to particular characteristics the method such as described succinctly above comprises a step of acknowledgment of the order by the computer system to be remote-controlled towards the centralized computer system and/or towards the calling terminal.

Thanks to these provisions the user is assured that he will be able to avail himself of the advantage offered by the computer system to be remote-controlled.

According to particular characteristics the method such as described succinctly above comprises a step of selecting an hour of activation of the order by the computer system to be remote-controlled and, at the selected hour, a step of implementing the order by the computer system to be remote-controlled.

Thanks to these provisions the user is able to organize his time until the order is implemented.

According to particular characteristics the method such as described succinctly above comprises a step of detecting, by the computer system to be remote-controlled, the end of its use.

Thanks to these provisions the computer system to be remote-controlled becomes again available for a new order.

According to particular provisions the method such as described succinctly above comprises a step of opening a communication session between the computer system to be remote-controlled and the centralized computer system as soon as the computer system to be remote-controlled is available.

Thanks to these provisions the computer system can be permanently informed of the availability of all the computer systems to be remote-controlled and invoicing can depend on the duration of use of the computer system to be remote-controlled.

According to particular characteristics the method such as described succinctly above comprises a second step of communication between a calling terminal, possibly different from the calling terminal that opened the first communication session, and the computer system to be remote-controlled, with the computer system to be remote-controlled implementing the order in response to this second session.

Thanks to these provisions, for instance, a handicapped person who has reserved a parking space causes the opening of a barrier or the lowering of a mobile terminal as he arrives in the vicinity of the parking space. The second step of communication then takes place before the use of the computer system to be remote-controlled.

Still thanks to these provisions, for instance, a handicapped person occupying a reserved space vacates it by causing the opening of a barrier or the lowering of a mobile terminal as he leaves the parking space. Furthermore, even if the communication with the computer system to be remote-controlled is unidirectional, the computer system is able to know when the computer system to be remote-controlled is available and when it is not. The second step of communication then takes place at the end of use of the computer system to be remote-controlled.

According to particular characteristics, the method described succinctly above comprises a step of questioning by a third party and a step of providing status data relative to one or several computer systems to be remote-controlled.

Thanks to these provisions, the authorized user has an authorization ticket or a virtual payment ticket and/or an unauthorized use can be known to surveillance or police services.

In accordance with a second aspect, this invention proposes a remote control device characterized by the fact that it comprises:
a means of opening of an initial communication session through the intermediary of a telecommunication network, between a calling terminal and a centralized computer system,
a means of transmitting an identifier of the user of the calling terminal to the centralized computer system and of an identifier of the computer system to be remote-controlled, through the intermediary of the telecommunication net,
a means of verifying said identifier by the centralized computer system,
the centralized computer system being adapted, if the verification is positive, to transmitting an authorization to the computer system to be remote-controlled, and
the computer system to be remote-controlled being adapted to implementing each order that has been authorized bu the computer system to be remote-controlled.

As the advantages, goals and particular characteristics of this device are similar to those of the method that has been described succinctly above, they are not repeated here.

### BRIEF DESCRIPTION OF THE SEVERAL VIEWS OF THE DRAWINGS

Other advantages, goals and characteristics of the present invention will become evident from the description that is going to follow and which is made as an explanation and in no way limitative with respect to the attached drawings.

FIG. 1 shows a schematic view of a terminal according to a particular mode of execution of the device which is the subject of this invention.

FIG. 2 shows a schematic illustration of a logical diagram of a first particular mode of execution of the method of this invention.

FIG. 3 shows a schematic illustration of a logical diagram of a first particular mode of execution of the method which is the subject of this invention.

FIG. 4 shows another schematic illustration of a logical diagram of a first particular mode of execution of the method which is the subject of this invention.

FIG. 5 shows still another schematic view of a logical diagram of a second particular mode of execution of the method which is the subject of this invention.

### DETAILED DESCRIPTION OF THE INVENTION

Although in the description which is going to follow, the invention is described with reference to a retractable parking barrier, this invention is not limited to this type of computer system to be remote-controlled but extends, on the contrary, to all system types that are capable of receiving remote-control signals.

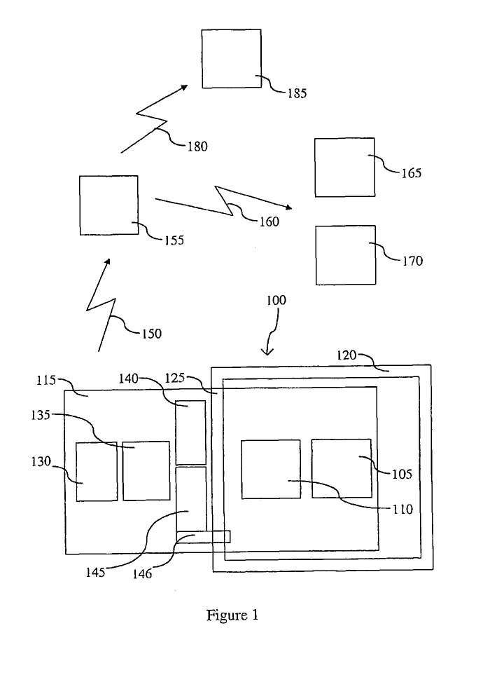

One can see in FIG. 1 a retractable parking barrier 100, comprising:
a vehicle detector 105,
a battery 110,
a fixed part 115,
a mobile part 120,
a rotational axis 125 of the mobile part 120, in relationship to the fixed part 115,
a modem 130, or any type of interface with a transmission network of known type,
an electronic card 135,
a motor 140; and
a reducer 145.

FIG. 1 also shows a first telecommunication network 150 which connects the retractable barrier 100 to a computer system 155 and a second telecommunication network 160 connecting the computer system 155 to a mobile user terminal 165 and to a fixed user terminal 170, a third telecommunication network 180 and a terminal for law enforcement agents 185.

The vehicle detector is of the known type. It provides a representative signal of the presence of a vehicle above the retractable barrier 100. For that purpose it uses for instance an induction loop the magnetic field of which is influenced by the presence of a metallic mass in proximity of the detector 105.

The battery 110 is of the known type. It supplies electric energy to all components of the retractable barrier 100. In some variants the battery 110 is replaced or complemented by a power supply from the power grid or from solar collectors.

The fixed part 115 and the mobile part 120 are made of rigid material and are capable of supporting the force applied by a vehicle that might roll over the retractable barrier 100. The fixed part 115 is attached to the ground by known means.

The mobile part 120 is moved around the rotational axis 125 by the motor 140, with the reducer 145 acting as an intermediary. The motor 140 and the reducer 145 are of known types. They include a torque limiter 146, between the reducer 145 and the mobile part 120 thus preventing the motor 140 or the reducer 145 from breaking, if the retractable barrier is forced by a vehicle.

The modem 130 is of the known type. It is able to receive signals from the first telecommunication network (not shown) and to demodulate them in order to provide information to the electronic card 135. The modem 130 has a unique address on the first telecommunication network, i.e., two different barriers 100 do not have the same address on the first telecommunication network.

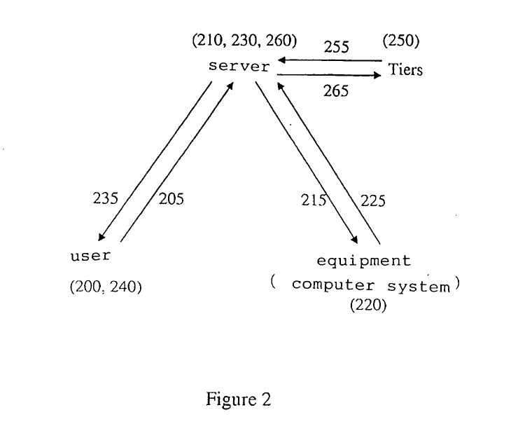

The electronic card 135 is capable of actuating the motor 140 and thus the position of the mobile part 120, in accordance with the signals it receives from the modem 130, as shown with respect to one or the other of FIGS. 2 to 5. The electronic card 135 is preferably architectured around a microprocessor. The electronic card 135 is able to detect a failure of one of the components of the barrier and to detect that the barrier has been forced.

The first telecommunication network 150 is for instance a mobile telephone network, of portable terminals or “pagers”. The modem 130 then includes an antenna and means to receive mobile telephone signals, for instance known for the transmission of short messages known under the acronym of “SMS” (for Short Message System). As a variant the first telecommunication network is a land line telephone network.

The computer system 155 consists for instance of a server storing a software implementing one of the logical diagrams shown in FIGS. 2 to 5 and at least one data base comprising the locations of the retractable barriers 100, the addresses of the retractable barriers on the first communication network and the identifiers of the persons authorized to make a reservation for one of the parking spaces equipped with retractable barriers 100.

The second telecommunication network 160 is for instance identical to the first telecommunication network or the Internet computer system. The mobile user terminal 165 is a cell phone and the fixed user terminal 170 is a computer of the known type, for instance under the name of PC (for Personal Computer), equipped with means of connecting to the second telecommunication network 160, for instance modem and navigation software on the Internet or a communicating terminal, for instance a PDA (personal digital assistant).

The third telecommunication network 180 is for instance identical to the first telecommunication network or the Internet computer system. The law enforcement terminal 185 is a terminal that is accessible to maintenance or traffic personnel. For instance the terminal 185 may be a communicating portable terminal or a fixed central surveillance terminal.

In a variant, the equipment to be remote-controlled includes a display unit (not shown) capable of displaying data concerning its utilization: For instance, the displayed data concern:
information that the equipment has been forced or that access has been authorized,
the duration of use of the equipment being considered,
payment for making available the equipment under consideration.

One can see, in FIG. 2, exchanges of information between the user of the calling terminal, a server of the centralized computer system and an equipment or computer system to be remote-controlled, in a first case of utilization where the user arrives near the equipment and reads on the equipment its identifier before calling the server.

During a step 200, the user calls the server, for instance by dialing or dictating a telephone number of the phone line to which the server is connected or by dictating an identifier of this line (for instance “remote control”) This phone number can be a complete or standard phone number (10 digits in France) or an abbreviated number with four, five or six digits.

Once the communication has been established (first communication session) during a step 205, the user transmits to the server his identifier and the identifier of the equipment which he has read on the equipment, identifiers which are unique.

During a step 210 the server verifies the identifier of the user.

For example, the server compares the phone number of the calling terminal against phone numbers of authorized users stored in a data base. According to another example, the server compares the number of the “SIM” card of the calling terminal when it includes one, for example if it is a cell phone with SIM card numbers stored in a data base of authorized users. According to yet another example, the server asks the user for a password, for example an authorization or card number giving the right of authorization (for instance a handicapped ID or a Social Security number and compares the information provided by the user with the content of a data base.

When the verification is negative, the server so advises the user and invites him to look for another space and to follow the necessary procedure for obtaining authorization to use the equipment. When the verification is positive during a step 215, the server sends a command to the equipment, for instance a command to open the barrier in the case shown in FIG. 1. In the case of equipment with individual access, during a step 220, this equipment executes the request, in this case to open the barrier. In case of equipment with shared access, for instance a multitude of parking spaces reserved for employees of an organization or for handicapped persons, the computer system to be remote-controlled provides the user by display, by printing a ticket, by communication through the intermediary of the server or by local communication (for instance by Bluetooth wireless technology), with an identifier of the space to occupy (for example “space 423, level 4, blue area”). Simultaneously the computer system to be remote-controlled orders the opening of an access barrier to the items of equipment and the opening of the equipment indicated.

Optionally, during a step 225, the equipment returns an acknowledgment to the server. The server then stores the occupied condition of the equipment during a step 230, and then during a step 235, returns an acknowledgment to the user whose terminal stores this acknowledgment during a step 240.

According to a first variant, when the user leaves the equipment, it automatically detects that it is available and sends a notice of availability to the server which the server stores and possibly determines the amount to be invoiced to the user.

According to a second variant, when the user leaves the equipment, he goes through the steps indicated above, the server possibly determining the amount to be invoiced to the user.

According to variants, if the equipment is forced or is out of order, it sends information to the server so that maintenance, or surveillance personnel or the police can intervene.

At any time, an authorized third party, provided for instance with a specific communicating terminal or whose access authorization has been verified as described above (see step 210) can enter into communication with the server, step 250, and send to it a status request concerning one or several items of equipment or computer systems to be remote-controlled, step 255. In response the server verifies the access authorization and prepares the requested data, step 260 and sends them to the terminal of the third party concerned, step 265.

For instance, the transmitted data concerns:
information that the equipment has been forced or that access has been authorized,
the duration of utilization of each equipment concerned,
the payment for making the equipment concerned available.

The method which is the subject of this invention thus allows generating virtual payment tickets which can be verified remotely.

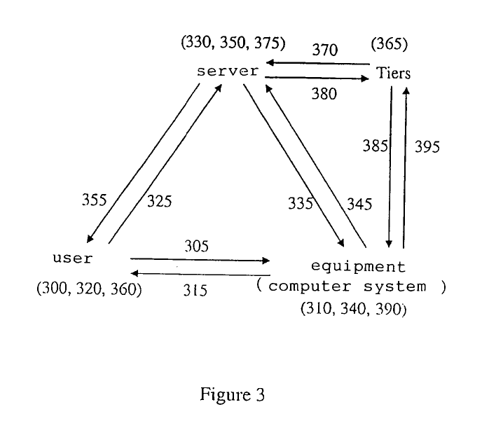

In FIG. 3 are shown exchanges of information between the user of the calling terminal, a server of the centralized computer system and an equipment or computer system to be remote-controlled, in a second case of utilization in which the user arrives near the equipment and obtains from the equipment its identifier before calling the server.

During a step 300, the user enters into local communication with the equipment (which may be with individual or collective access) for instance in accordance with the local Bluetooth communication standard. When the communication is established, the user's terminal asks the equipment for its identifier, during a step 305, and, during a step 310 the equipment prepares its response and returns this identifier during a step 315.

One observes that considerable other information can thus be provided by the equipment to the user's terminal, during step 315, for instance, tourist information, the location of emergency services, useful addresses and/or advertising for local services or merchants.

During a step 320, the user's terminal stores the information received during step 315. Then, during a step 325, the user calls the server, for instance by dialing or dictating a phone number of a phone line to which the server is connected or by dictating an identifier of this line (for example “remote control”). This phone number can be a complete or standard phone number (10 digits in France) or an abbreviated number with four, five or six digits. Once the communication has been established (first communication session) the user sends to the server his identifier and the identifier of the equipment. During a step 330, the server verifies the user's identifier.

For example, the server compares the phone number of the calling terminal with phone numbers of authorized users stored in a data base. According to another example, the server compares the number of the “SIM” card of the calling terminal, if it has one, for instance if it is a cell phone with SIM numbers stored in a data base of authorized users. According to yet another example, the server asks the user for a password, for instance an authorization or card number giving the right of authorization (for instance a handicapped ID or a Social Security number) and compares the information provided by the user with the content of a data base.

When the verification is negative, the server so advises the user and invites him to look for another space and to follow the necessary procedure for obtaining authorization to use the equipment. When the verification is positive, during a step 335, the server sends a command to the equipment, for instance a command to open the barrier in the case illustrated in FIG. 1. In the case of equipment for individual access, during a step 340, this equipment carries out the requested command, here an opening of the barrier. In the case of equipment with shared access, for instance a number of parking spaces reserved for employees of an organization or for handicapped persons, the computer system to be remote-controlled provides the user, by display, by printing of a ticket, by communication through the intermediary of the server or by local communication (for instance by wireless technology, according to the Bluetooth communication standard) with an identifier of the space to occupy (for instance, “space 423, level 4, blue area”). Simultaneously, the computer system to be remote-controlled requests the opening of a barrier giving access to the equipment and the opening of the equipment indicated.

Optionally, during a step 345, the equipment returns an acknowledgment to the server. The server then stores the occupied status of the equipment during a step 350, then, during a step 355, returns an acknowledgment to the user whose terminal stores this acknowledgment during a step 360.

According to a first variant, when the user leaves the equipment, it automatically detects that it is available and sends an information of availability to the server which the server stores and possibly determines the amount to invoice the user.

According to a second variant, when the user leaves the equipment it performs the steps indicated above, with the server possibly determining the amount to charge the user. According to other variants, if the equipment is forced or out of order, it sends information to the server so that maintenance, surveillance or police personnel can intervene.

At any time, an authorized third party, provided for instance with a specific communicating terminal or whose access authorization has been verified as described above (see step 330) can enter into communication with the server, step 365, and send to it a status request concerning one or several items of equipment or computer systems to be remote-controlled, step 370. In response the server verifies the access authorization and prepares the requested data, step 375 and sends it to the terminal of the third party concerned, step 380.

The authorized third party may also enter into communication with the equipment concerned, for instance in local wireless communication, step 365 and send it a status request, step 385. In response the equipment verifies the access authorization, possibly with a communication with the server, prepares the requested data, step 390 and sends it to the terminal of the third party in question, step 395.

In both cases, the data sent may in particular concern: the information that the equipment has been forced or that access was authorized, the duration of utilization of each item of equipment concerned, the payment for making the equipment concerned available.

The method which is the subject of this invention thus allows for generating virtual payment tickets which can be verified remotely.

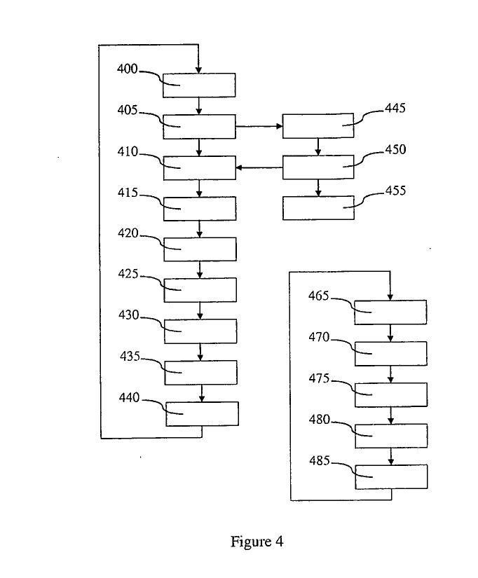

FIG. 4 shows a succession of steps that are put into place in a case where the user reserves, in advance, a resource that is managed by an equipment or a computer system to be remote-controlled, through the intermediary of a computer network, the Internet for example.

During a step 400, the calling terminal initiates the opening of a first communication session through the intermediary of the second telecommunication network, between a calling terminal, for example the fixed user terminal 170 and the centralized computer system 155. For example, the user activates a navigator to select a site that is dedicated to this application, on the Internet or calls by telephone a service known under the name of audiotel.

Then, during a step 405, the centralized computer system identifies the user of the calling terminal. For example, the centralized computer system compares the phone number of the calling terminal with phone numbers of authorized users in a data base. According to another example, the centralized computer system compares the number of the “SIM” card of the calling terminal, if it is has one, for example, if it is a cell phone with SIM card numbers stored in a data base of authorized users.

According to another example, the centralized computer system asks the user for a password, for instance an authorization number or the number of a card entitling [the user] to the authorization (for example a handicapped ID or a Social Security number) and compares the information provided by the user with the content of a data base.

Each parking barrier or equipment to be controlled is identified by a unique alphanumerical code displayed on the equipment so the user can read it without having to leave his vehicle and be sent by the user over his cell phone.

If the authorization verification of step 405 is negative, during a step 445 the centralized computer system so advises the user and in a step 450 he is given an opportunity to enroll in the service. For example, enrollment in the service requires a Social Security number or a handicapped ID or a bank card. If enrollment is not made correctly (for example because the user is not entitled to the service or because he refuses to give the requested information) the process terminates during a step 455.

If the authorization verification of step 405 is positive or if the enrollment made during step 450 has been realized correctly, during a selection step 410 the user of the calling terminal selects a computer system to be remote-controlled, for example a parking space reserved for the handicapped. For instance the user provides the address where he wants to go and the date of his trip and the computer system gives him a choice of available parking spaces for that date among which the user selects a space.

In case the user activates, as he approaches his destination, a geo-locatable terminal, for instance by locating a cell in which the cell phone is located or by means of position determination technology by referring to signals emitted by satellites, known under the name of GPS (for “Global Positioning System”) or through Galileo or through a positioning system integrated in the vehicle, the central server provides the user with a reduced list of available facilities within the vicinity of the user's location, as well as their physical addresses (by reference to the building number in a street and/or the position on a map displayed for the user with its geo-located position and the position of various itineraries).

During a validation step 415, the user validates the selection he has made during step 410 and possibly pays for the service, i.e., for instance the price for parking in the selected space, or gives an authorization for payment in case of a season ticket or a term payment, possibly by extra-billing on a telephone bill.

During a step 420, the computer system opens a second communication session, through the intermediary of a second telecommunication channel, with the selected computer system to be remote-controlled. For instance, the computer system dials up the unique address of the computer system to be remote-controlled on the second telecommunication network 160 (for example a telephone number, if it involves a telephone network).

When the second communication session is opened, during a step 425 the computer systems send a command to the computer system to be remote-controlled so that it will be available to the user immediately or on the selected date.

During a step 430, the computer system records in its memory that the computer system to be remote-controlled is no longer available, either immediately or at the selected date.

The logical diagram shown in FIG. 4 can function in real time, for instance when the user has already found the available parking space and triggers, with his cell phone, the opening of the parking barrier 100, if no other user has reserved it.

When the user leaves the parking space, during a step 435, the user opens a new communication session with the computer system and selects the end of the reservation which, if applicable, corresponds also to the end of the billing period of the user. The computer system then opens a communication session with the computer system to be remote-controlled and causes the retractable parking barrier 100 to close, as soon as the vehicle detector 105 indicates that there is no longer a vehicle in that parking space.

During a step 440 the computer system records in its memory that the computer system to be remote-controlled is again available.

If the computer system to be remote-controlled detects that it has been forced or is out of order, during a step 465, the computer system to be remote-controlled sends an alarm signal to the centralized computer system during a step 470. During a step 475 the centralized computer system informs maintenance, surveillance or police service of the event in question.

During a step 480, the service intervenes and repairs or releases the computer system to be remote-controlled, and during a step 485, the computer system to be remote-controlled sends a status signal to the centralized computer system to indicate that it is available or operational, respectively.

The interrogation made by a third party as described with respect to FIGS. 2 and 3, has not been repeated here for the sake of brevity, but it can be performed as a complement of the steps described with respect to FIG. 4.

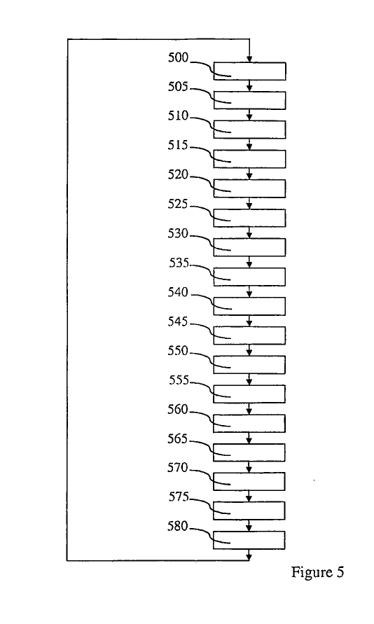

FIG. 5 shows a succession of steps that are put into operation in a case where the user reserves in advance a resource that is managed by an equipment or computer system to be remote-controlled, through the intermediary of a computer network, for example the Internet.

During a step 500, the calling terminal initiates the opening of a first communication session through the intermediary of at least one telecommunication channel, between a calling terminal and a centralized computer system.

Then during a step 505, the centralized computer system identifies the user of the calling terminal. If the authorization verification performed during step 505 is negative, steps (not shown) equivalent to steps 445 to 460 are carried out.

If the authorization verification of step 505 is positive, then during a step 510, the user of the calling computer system selects a date and time of activation of the order he is going to place.

During a step 515, the computer system researches the computer systems to be remote-controlled that are available at the selected date and time. During a step 520, the user of the calling terminal selects an available computer system to be remote-controlled.

During a step 525, the user validates the selection of the computer system to be remote-controlled, for instance by paying for his reservation.

During a step 530, the computer system opens a second communication session, through the intermediary of a second telecommunication channel, between said computer system and the selected computer system to be remote-controlled.

During a step 535, the computer system sends a command to the selected computer system to be remote-controlled and provides it with an identifier of the user, for example his cell phone number or the number of a SIM card.

During a step 540, the computer system stores the unavailability of the computer system to be remote-controlled for a predetermined duration, for instance half a day, depending on the time selected by the user.

During a step 545, the computer system to be remote-controlled acknowledges the order to the computer system and during a step 550, the computer system confirms the order to the calling terminal.

When the user is within proximity of the remote-controlled system, during a step 555, the user opens a third communication session between a calling terminal, possibly different from the calling terminal that opened the first communication session, and the computer system to be remote-controlled. In response, during a step 560, the computer system to be remote-controlled identifies the user and executes the order, for example the opening of a reserved parking barrier.

At the time of execution of the order, during a step 560, the computer system carries out a first incrementation of a counter (meter) assigned to the user and corresponding to the billing for the service rendered and, in the case of pricing depending on a length of space occupation this incrementation is continued up to step 570.

During a step 565, the computer system to be remote-controlled detects the end of its utilization, for instance the absence of any vehicle in the parking space.

During a step 570, the computer system to be remote-controlled opens a fourth communication session between the computer system to be remote-controlled and the computer system.

As a variant, when he leaves the parking space, during a step 575, the user opens a fifth communication session with the computer system to be remote-controlled or with the computer system and, during a step 580, the computer system to be remote-controlled executing a command in response to this fourth session.

One notes that this fifth communication session can be performed by the user with a calling terminal that is different from the calling terminal that opened the first communication session.

The interrogation performed by a third party such as described with respect to FIGS. 2 and 3 has not been repeated here for the sake of brevity, but it can be performed as a complement to the steps described with respect to FIG. 5.

As a variant of the execution modes described above, when a user who has not reserved the parking space arrives within proximity of this space, he opens a communication session with the system to be remote-controlled which then identifies the user, possibly by consulting a data base maintained by the computer system or an internal data base (on the basis of the cell phone number or of the SIM card number). If the identification is positive (the user is authorized to park in the parking space access to which is guarded by the system to be remote-controlled), the system to be remote-controlled indicates in response to the user, for how long it is still available. If the user accepts the indicated availability (he will be subject to extra-billing, if he encroaches upon the reservation made for this space at a later date or time), he confirms his order. In response, the system to be remote-controlled executes the command (for example opens a parking barrier) and opens a communication session with the computer system to inform it of its unavailability. When the space is again available (by detection of the absence of a vehicle) the remote-controlled system opens a new communication session with the computer system to indicate its availability.

In each of the execution modes described above several categories of users can be managed by the methods and remote-control devices which are the subject of this invention. For example, emergency services can be authorized at any time to use each of the remote-controlled facilities; a physician can be authorized to use it, provided another handicapped [parking] space is available nearby and for no more than 30 minutes, and handicapped persons can be authorized to use it for two hours maximum.

This invention applies to all cases where authorized users can access a resource after execution of a command by a computer system to be remote-controlled among a multitude of computer systems to be remote-controlled. For example, this invention applies to aid in mobility in all its forms, elevators reserved for handicapped persons in public places and other reserved public facilities. More generally, the invention applies to providing access to public transport (by opening doors), to premises, to information terminals, to company vehicle fleets (the system to be remote-controlled then being the vehicle the doors of which one commands to open).

We claim:

1. Remote-control process comprising:
opening a first communication session through an intermediary of a telecommunication network between a calling terminal and a centralized computer system;
sending an identifier of a user of the calling terminal to the centralized computer system and of an identifier of a computer system to be remote-controlled, through the intermediary of the telecommunication net;
verifying said identifier by the centralized computer system; and
if verification is positive, sending an authorization, from the centralized computer system to the computer system to be remote-controlled and executing the authorized command by the computer system to be remote-controlled.

2. Process according to claim 1, further comprising:
as a preliminary to the step of sending an identifier of a computer system to be remote-controlled, through the intermediary of the telecommunication network, communicating between the computer system to be remote-controlled and the calling terminal, during which the computer system to be remote-controlled sends its identifier to the calling terminal.

3. Process according to claim 1, further comprising:
in case of unauthorized use of the computer system to be remote-controlled, communicating, during which the computer system to be remote-controlled sends a representative message of unauthorized utilization.

4. Process according to claim 1, further comprising:
verifying availability of the computer system to be remote-controlled, by the centralized computer system.

5. Process according to claim 1, further comprising:
acknowledging a command by the computer system to be remote-controlled towards the centralized computer system and/or towards the calling terminal.

6. Process according to claim 1, further comprising:
selecting a time of activating the order by the computer system to be remote-controlled and,
at a selected time, executing the order by the computer system to be remote-controlled.

7. Process according to claim 1, further comprising:
detecting, by the computer system to be remote-controlled, an end of utilization thereof.

8. Process according to claim 7, further comprising:
opening a communication session between the computer system to be remote-controlled and the centralized computer system, as soon as the computer system to be remote-controlled is available.

9. Process according to claim 1, further comprising:
a second communicating between a calling terminal that is possible different from the calling terminal which opened the first communication session, and the computer system to be remote-controlled, with the computer system to be remote-controlled executing the order in response to this second session.

10. Process according to claim 1, further comprising:
interrogating by a third party and providing status data concerning one or several computer systems to be remote-controlled.

11. Remote control device comprising:
means for opening a first communication session through an intermediary of a telecommunication network, between a calling terminal and a centralized computer system,
means of transmitting an identifier of a user of the calling terminal to the centralized computer system and of an identifier of a computer system to be remote-controlled, through the intermediary of the telecommunication network, a means of verifying said identifier by the centralized computer system,
a centralized computer system being able, if the verification is positive, to send an authorization to the computer system to be remote-controlled; and being remote-controlled to able to execute each command that has been authorized by the computer system to be remote-controlled.
